(19) United States
(12) Patent Application Publication
(10) Pub. No.: US 2026/0217175 A1
(43) Pub. Date: Jul. 30, 2026

(54) VEHICLE SEAT

(71) Applicants: TS TECH CO., LTD., Saitama (JP); HONDA MOTOR CO., LTD., Tokyo (JP)

(72) Inventors: Hidetsune NONAKA, Tochigi (JP); Ikumaru NOZAWA, Tochigi (JP); Manabu MATSUMOTO, Tokyo (JP); Hinako YOKOYAMA, Tokyo (JP)

(21) Appl. No.: 19/418,123

(22) Filed: Dec. 12, 2025

(30) Foreign Application Priority Data
Dec. 26, 2024 (JP) 2024-231185

(51) Int. Cl. B60N 2/879; B60N 2/58; B60R 21/207

(52) U.S. Cl. CPC B60N 2/879; B60N 2/5825; B60R 21/207

(57) ABSTRACT

A vehicle seat includes: a seat body including a frame, a pad member supported by the frame, and a skin material covering an outer surface of the pad member; and a speaker device including a speaker box and a speaker grill. The speaker box is coupled to a wire member provided on the frame, the speaker grill is coupled to the wire member via an attachment member, the skin material is provided with an opening for allowing sound emitted from the speaker box to pass through, and the speaker grill is coupled to the attachment member with an edge portion of the opening sandwiched between the speaker grill and the attachment member.

### TECHNICAL FIELD

The present invention relates to a vehicle seat

### BACKGROUND ART

A vehicle seat may be provided with a speaker device to provide a more immersive acoustic experience and sound tailored to the taste of each seated person

JP2021-23463A discloses a speaker structure for vehicles consisting of a speaker device including a speaker body and a speaker grill, and a seat back

The seat back disclosed in JP2021-23463A includes a seat pad and a seat cover that covers the seat pad. The seat pad is provided with a through hole extending in a front-and-rear direction. The speaker body is arranged behind the through hole, and the speaker grill is arranged inside the through hole to seal the through hole. A peripheral edge of the speaker grill is pressed against a seat pad portion that forms an inner wall of the through hole through a corresponding portion of the seat cover. This prevents a gap from occurring between the speaker grill and the seat pad

JP7040317B discloses a vehicle seat including a seat back with a speaker installed inside

The seat back disclosed in JP7040317B includes a pad member made of soft urethane, and a skin attached to the outer surface thereof. The pad member is provided with an opening extending in the front-and-rear direction as in JP2021-23463A, and the speaker is arranged behind the opening. The skin is provided with a hole corresponding to the opening, and a ring-shaped elastic member made of relatively hard urethane is provided at an edge portion. The elastic member is fitted into an inner wall of the opening, and the speaker grill is fitted into the elastic member to cover the opening

As disclosed in JP2021-23463A and JP7040317B, when holes are formed in the skin, the edge portion defining the hole in the skin may peel off. Accordingly, there is a need to develop a technique for stably fixing the edge portion of the skin when the holes are formed in the skin

### SUMMARY OF THE INVENTION

In view of the above background, it is an object of the present invention to provide, in a vehicle seat provided with a speaker device, an opening in a skin material for allowing sound generated by the speaker device to pass through, and to stably fix an edge portion of the opening

To achieve such an object, one aspect of the present invention provides a vehicle seat (1) including: a seat body (2) including a frame (22), a pad member (11) supported by the frame, and a skin material (12) covering an outer surface of the pad member; and a speaker device (3) including a speaker box (25) and a speaker grill (26), and the speaker box is coupled to a wire member (33) provided on the frame, the speaker grill is coupled to the wire member via an attachment member (45), the skin material is provided with an opening (80) for allowing sound emitted from the speaker box to pass through, and the speaker grill is coupled to the attachment member with an edge portion of the opening sandwiched between the speaker grill and the attachment member

According to this aspect, the edge portion of the opening in the skin material is sandwiched between the speaker grill and the attachment member. Accordingly, it is possible to provide the opening in the skin material for allowing the sound generated by the speaker device to pass through, and to stably fix the edge portion of the opening

In the above aspect, preferably, one of the speaker grill and the attachment member is provided with a locking portion (66, 66A) protruding toward the other of the speaker grill and the attachment member, the other of the speaker grill and the attachment member is provided with a locked portion (68, 68A) to be locked to the locking portion protruding from the one of the speaker grill and the attachment member, and the skin material is provided with a locking hole (82) for allowing the locking portion to pass through

According to this aspect, it is possible to prevent the skin material from detaching from between the speaker grill and the attachment member

In the above aspect, preferably, one of the speaker grill and the attachment member is provided with a locking portion (66, 68B) protruding toward the other of the speaker grill and the attachment member, the other of the speaker grill and the attachment member is provided with a locked portion (68, 68B) to be locked to the locking portion protruding from the one of the speaker grill and the attachment member, and the locking portion passes through the opening

According to this aspect, it is possible to prevent the skin material from detaching from between the speaker grill and the attachment member

In the above aspect, preferably, the skin material is provided with a reinforcing portion (88) extending along the edge portion of the opening

According to this aspect, it is possible to reinforce the edge portion

In the above aspect, preferably, the reinforcing portion projects from a back surface of the skin material, and the attachment member is provided with a receiving recess (52) for receiving the reinforcing portion

According to this aspect, the skin material can be appropriately positioned by receiving the reinforcing portion in the receiving recess

In the above aspect, preferably, the edge portion of the opening is provided with a notch (86) cut outward, the locking portion passes through the notch and engages with the locked portion, and the reinforcing portion is arranged at a position that avoids the notch

According to this aspect, it is possible to easily engage the locking portion with the locked portion

In the above aspect, preferably, the attachment member is provided with a central hole, and a supporting piece (54) extending inward is provided on an edge portion of the central hole

According to this aspect, it is possible to prevent slack of the skin material from occurring while reducing the weight of the attachment member

In the above aspect, preferably, the speaker box is provided with two speaker bodies (28), the attachment member includes two holes (48) spaced apart from each other in a lateral direction, and a central hole (50) arranged in a center of the holes, each hole is arranged at a position that overlaps the corresponding speaker body, and left and right edges of the central hole are provided with supporting pieces (54) extending in directions approaching each other, respectively

According to this aspect, it is possible to effectively prevent slack of the skin material from occurring while reducing the weight of the attachment member

In the above aspect, preferably, the skin material is provided with at least one latching hole (78), the attachment member is provided with a latching portion (84) where the latching hole is latched, and the skin material is provided with a tongue piece (76) for an operator to grasp when the latching hole is latched onto the latching portion

According to this aspect, it is possible to couple the skin material to the attachment member using the tongue piece

In the above aspect, preferably, the tongue piece is formed by an upper edge of the skin material being folded back to a back surface and sewn, and forms a bag-like shape with openings on left and right sides

According to this aspect, it is possible to easily couple the skin material to the attachment member using the tongue piece

In the above aspect, preferably, the frame includes a seat back frame (10) forming a framework of a seat back, and a headrest stay (21) coupled to an upper portion of the seat back frame, the wire member is coupled to the headrest stay, and the attachment member is fixed to the wire member

According to this aspect, it is possible to couple the attachment member to the frame with a simple configuration

In the above aspect, preferably, the frame includes a seat back frame (10) forming a framework of a seat back, and a headrest stay (21) extending upward from an upper end of the seat back frame, an airbag module (18) including an airbag (18A) configured to deploy forward is provided in a lower portion of the seat back frame, and the attachment member is coupled to the headrest stay

According to this aspect, it is possible to arrange the speaker device at a position where the deployment of the airbag is not interfered with

### EFFECT OF THE INVENTION

One aspect of the present invention provides a vehicle seat (1) including: a seat body (2) including a frame (22), a pad member (11) supported by the frame, and a skin material (12) covering an outer surface of the pad member; and a speaker device (3) including a speaker box (25) and a speaker grill (26), and the speaker box is coupled to a wire member (33) provided on the frame, the speaker grill is coupled to the wire member via an attachment member (45), the skin material is provided with an opening (80) for allowing sound emitted from the speaker box to pass through, and the speaker grill is coupled to the attachment member with an edge portion of the opening sandwiched between the speaker grill and the attachment member

According to this aspect, the edge portion of the opening in the skin material is sandwiched between the speaker grill and the attachment member. Accordingly, it is possible to provide the opening in the skin material for allowing the sound generated by the speaker device to pass through, and to stably fix the edge portion of the opening

In the above aspect, preferably, one of the speaker grill and the attachment member is provided with a locking portion (66, 66A) protruding toward the other of the speaker grill and the attachment member, the other of the speaker grill and the attachment member is provided with a locked portion (68, 68A) to be locked to the locking portion protruding from the one of the speaker grill and the attachment member, and the skin material is provided with a locking hole (82) for allowing the locking portion to pass through

According to this aspect, it is possible to prevent the skin material from detaching from between the speaker grill and the attachment member

In the above aspect, preferably, one of the speaker grill and the attachment member is provided with a locking portion (66, 68B) protruding toward the other of the speaker grill and the attachment member, the other of the speaker grill and the attachment member is provided with a locked portion (68, 68B) to be locked to the locking portion protruding from the one of the speaker grill and the attachment member, and the locking portion passes through the opening

According to this aspect, it is possible to prevent the skin material from detaching from between the speaker grill and the attachment member

In the above aspect, preferably, the skin material is provided with a reinforcing portion (88) extending along the edge portion of the opening

According to this aspect, it is possible to reinforce the edge portion

In the above aspect, preferably, the reinforcing portion projects from a back surface of the skin material, and the attachment member is provided with a receiving recess (52) for receiving the reinforcing portion

According to this aspect, the skin material can be appropriately positioned by receiving the reinforcing portion in the receiving recess

In the above aspect, preferably, the edge portion of the opening is provided with a notch (86) cut outward, the locking portion passes through the notch and engages with the locked portion, and the reinforcing portion is arranged at a position that avoids the notch

According to this aspect, it is possible to easily engage the locking portion with the locked portion

In the above aspect, preferably, the attachment member is provided with a central hole, and a supporting piece (54) extending inward is provided on an edge portion of the central hole

According to this aspect, it is possible to prevent slack of the skin material from occurring while reducing the weight of the attachment member

In the above aspect, preferably, the speaker box is provided with two speaker bodies (28), the attachment member includes two holes (48) spaced apart from each other in a lateral direction, and a central hole (50) arranged in a center of the holes, each hole is arranged at a position that overlaps the corresponding speaker body, and left and right edges of the central hole are provided with supporting pieces (54) extending in directions approaching each other, respectively

According to this aspect, it is possible to effectively prevent slack of the skin material from occurring while reducing the weight of the attachment member

In the above aspect, preferably, the skin material is provided with at least one latching hole (78), the attachment member is provided with a latching portion (84) where the latching hole is latched, and the skin material is provided with a tongue piece (76) for an operator to grasp when the latching hole is latched onto the latching portion

According to this aspect, it is possible to couple the skin material to the attachment member using the tongue piece

In the above aspect, preferably, the tongue piece is formed by an upper edge of the skin material being folded back to a back surface and sewn, and forms a bag-like shape with openings on left and right sides

According to this aspect, it is possible to easily couple the skin material to the attachment member using the tongue piece

In the above aspect, preferably, the frame includes a seat back frame (10) forming a framework of a seat back, and a headrest stay (21) coupled to an upper portion of the seat back frame, the wire member is coupled to the headrest stay, and the attachment member is fixed to the wire member

According to this aspect, it is possible to couple the attachment member to the frame with a simple configuration

In the above aspect, preferably, the frame includes a seat back frame (10) forming a framework of a seat back, and a headrest stay (21) extending upward from an upper end of the seat back frame, an airbag module (18) including an airbag (18A) configured to deploy forward is provided in a lower portion of the seat back frame, and the attachment member is coupled to the headrest stay

According to this aspect, it is possible to arrange the speaker device at a position where the deployment of the airbag is not interfered with

### BRIEF DESCRIPTION OF THE DRAWINGS

FIG. 1 is a perspective view of a vehicle seat

FIG. 2 is a perspective view showing an upper half of a frame of a seat body, and a portion of a support member

FIG. 3 is an exploded perspective view of an upper portion of the vehicle seat

FIG. 4 is a perspective view showing the upper portion of the vehicle seat with a speaker grill, a skin material, and an attachment member removed

FIG. 5 is a cross-sectional view taken along a line V-V of FIG. 1

FIG. 6A is a front view of a rear grille

FIG. 6B is a back view of the rear grille

FIG. 7A is a front view of the attachment member

FIG. 7B is a back view of the attachment member

FIG. 8A is a back view showing a coupling between the attachment member and a first wire member

FIG. 8B is an explanatory diagram for explaining the coupling between the attachment member and the first wire member in an area surrounded by the two-dot chain line in FIG. 8A

FIG. 9 is a back view showing a state where the speaker grill is coupled to the attachment member

FIG. 10 is a perspective view showing a state where an upper back panel is removed

FIG. 11 is a back surface view of the skin material

FIG. 12 is a rear view of the upper portion of the vehicle seat according to a modified embodiment

FIG. 13A is a perspective view showing a first bracket according to the modified embodiment, and the upper half of a frame on which the first bracket is provided; and

FIG. 13B is an enlarged view of a portion XIIIB in FIG. 13A

### DETAILED DESCRIPTION OF THE INVENTION

In the following, an embodiment in which a vehicle seat according to the present invention is applied to an automotive seat installed in a vehicle such as an automobile will be described with reference to the drawings. In the following description, for the sake of convenience, directions such as up, down, front, rear, left, and right are defined relative to the direction of a seated person sitting in the vehicle seat. However, the present invention is not limited to these directions

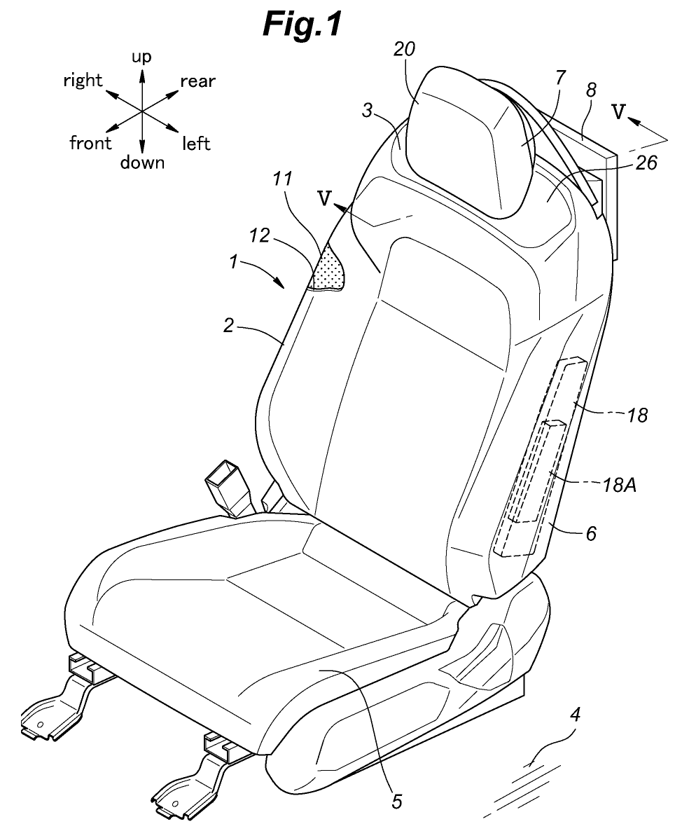

As shown in FIG. 1, the vehicle in which a vehicle seat 1 is installed is provided with front and rear seats arranged in two rows in the front-and-rear direction. The vehicle seat 1 constitutes a front passenger seat provided beside the driver's seat among the front seats

However, the vehicles to which the vehicle seat 1 is applied are not limited to vehicles provided with the two rows of seats in the front-and-rear direction. For example, the vehicle seat 1 may be applied to a vehicle provided with three rows of seats in the front-and-rear direction, and may constitute the front seat provided in the front row

The vehicle seat 1 includes a seat body 2, and a speaker device 3. The seat body 2 includes a seat cushion 5 arranged on a floor 4, the seat back 6 coupled to the rear portion of the seat cushion 5, and a headrest 7 provided on the upper portion of a seat back 6

The speaker device 3 is incorporated in the upper portion of the seat body 2. By providing the speaker device 3 in the upper portion of the seat back 6, the speaker device 3 can be arranged in a position close to the ears of the seated person. Accordingly, it is possible to provide each seated person in the vehicle seat 1 with an immersive acoustic experience, and music and audio content tailored to the taste of each seated person

Further, a display 8 is provided on the back surface of the vehicle seat 1 for the seated person in the rear seats

Next, the details of the structure of the upper portion of the seat body 2, and the details of the configuration of the speaker device 3 will be described

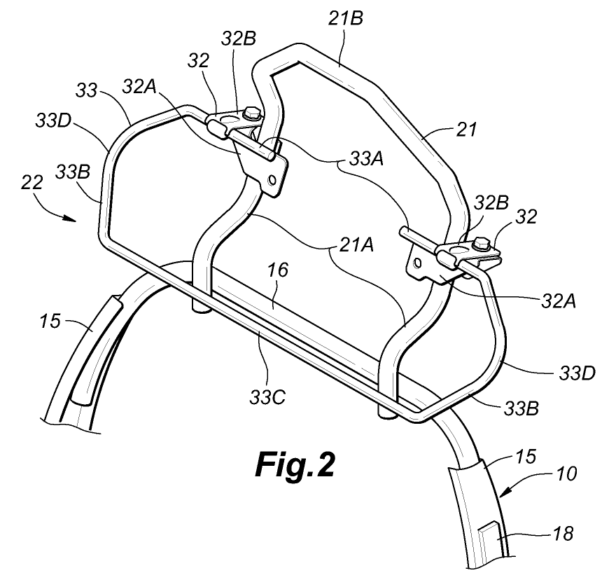

As shown in FIG. 1, the upper portion of the seat body 2 consists of the seat back 6 and the headrest 7. The seat back 6 includes a seat back frame 10 (see FIG. 2) forming a framework of the seat back 6, a pad member 11 supported by the seat back frame 10, and a skin material 12 covering the outer surface of the pad member 11. In FIG. 1, the seat back 6 is shown in a state where a part of the upper right portion of the skin material 12 is peeled off to show the internal structure of the seat back 6

The seat back frame 10 includes a pair of left and right side members 15 extending vertically, an upper frame 16 extending laterally and connecting the upper portions of the left and right side members 15, and a lower frame (not shown) extending laterally and connecting the lower portions of the left and right side members 15

The lower ends of the left and right side members 15 may be coupled to a frame (not shown) forming the framework of the seat cushion 5 via a reclining mechanism (not shown). At least one of the left and right side members 15 is provided with an airbag module 18 at the lower portion thereof. The airbag module 18 houses the airbag 18A that deploys forward. In the present embodiment, as shown in FIGS. 1 and 2, the airbag module 18 is coupled to the left side surface of the left side member 15

The headrest 7 includes a headrest body 20 (see FIG. 1). The headrest body 20 is coupled to the seat back frame 10 via the headrest stay (hereinafter referred to as a stay 21, see FIG. 2

The headrest body 20 has a substantially rectangular parallelepiped shape and is arranged behind the head of the seated person. The headrest body 20 preferably includes a pad member (not shown) having cushioning properties and a skin material (not shown) covering the front surface of the pad member

As shown in FIG. 2, the stay 21 is made of a bent metal round pipe material. The stay 21 includes a pair of left and right vertical portions 21A, and a lateral portion 21B connecting the upper ends of the left and right vertical portions 21A. The vertical portions 21A extend substantially in the up-and-down direction. The vertical portion 21A is coupled to the upper frame 16 at the lower portion. Accordingly, the stay 21 is coupled to the upper portion of the seat back frame 10, and is supported by the seat back frame 10. The stay 21 may be directly fixed to the seat back frame 10 by welding and the like, or may be coupled to the seat back frame 10 via a tubular pillar guide (not shown)

The headrest body 20 is coupled to the upper portion of the stay 21, and is supported by the upper frame 16 via the stay 21. The stay 21 and the seat back frame 10 cooperate with each other to constitute the upper half of a seat frame 22 that forms the upper framework of the seat body 2. The lower portion of the stay 21, i.e., the lower half of the vertical portion 21A, constitutes a headrest pillar that couples the headrest body 20 to the seat back frame 10

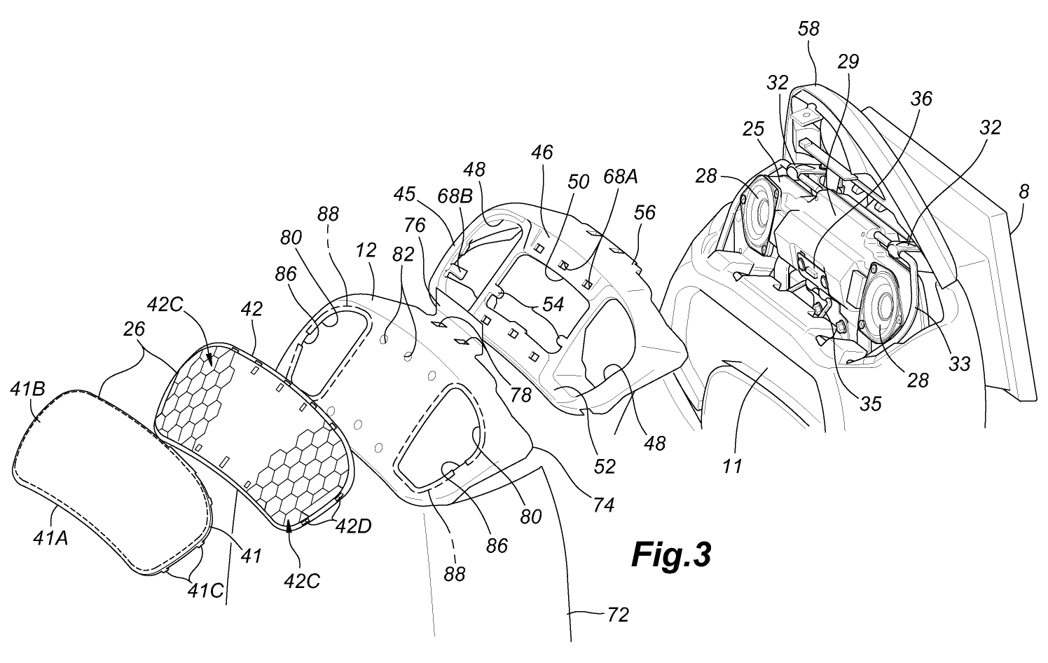

As shown in FIG. 3, the speaker device 3 includes a speaker box 25 and a speaker grill 26

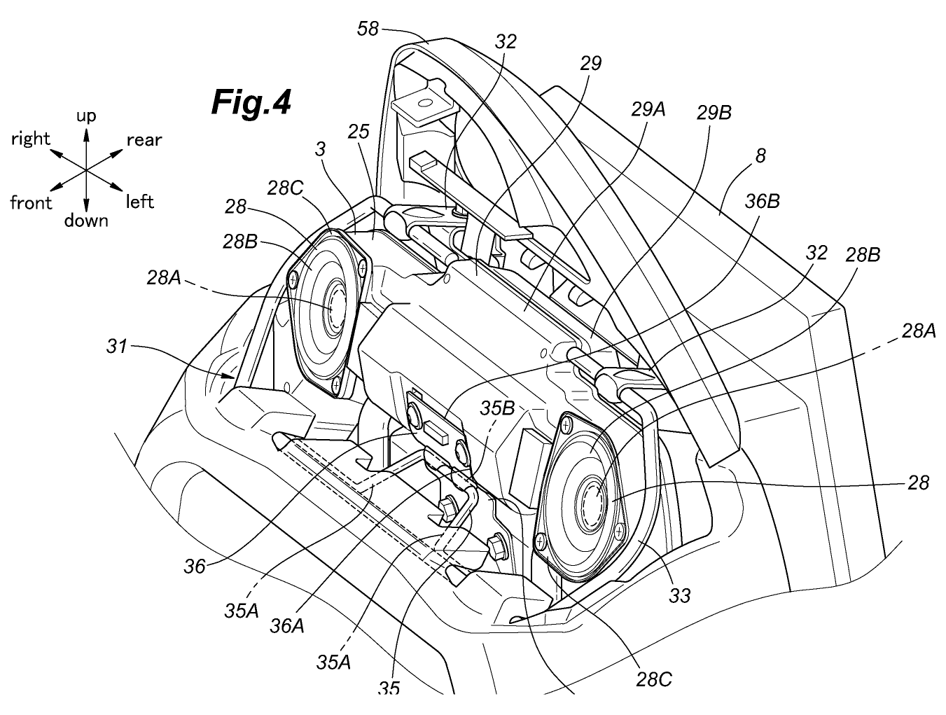

As shown in FIG. 4, the speaker box 25 includes two speaker bodies 28 (also referred to as speaker drivers) and a housing 29. Each speaker body 28 includes a compression driver 28A as a sound source that generates sound, and a horn unit 28B having a substantially truncated cone shape. The housing 29 includes a front member 29A that constitutes the front half thereof and a rear member 29B that constitutes the rear half thereof. The front member 29A and the rear member 29B are coupled to each other to form a sealed internal space (cavity)

The front surface of the front member 29A is provided with two mounting holes (not shown) for accommodating the speaker body 28. The speaker body 28 is arranged so that the horn units 28B are open forward and are accommodated in the mounting holes. The tips of the horn units 28B are coupled to flanges 28C extending radially outward, the flanges 28C are fastened to the front member 29A, and thus the speaker body 28 is coupled to the speaker box 25. However, the speaker body 28 may be coupled to the speaker box 25 by a method other than fastening (such as adhesion)

The stay 21 is provided with a support member 31 for supporting the speaker box 25. The support member 31 is made of a metal member and constitutes a portion of the seat frame 22 forming the framework of the upper half of the seat body 2

The support member 31 includes a pair of left and right first brackets 32 (see also FIG. 2), a first wire member 33 (see also FIG. 2), a second wire member 35, and a second bracket 36

As shown in FIG. 2, the first brackets 32 are connected to the vertical portions 21A of the stay 21, respectively. The first bracket 32 includes a laterally extending portion 32A that is connected to the vertical portion 21A and extends laterally outward, and a forwardly extending portion 32B that extends forward from the upper edge of the laterally extending portion 32A

The first wire member 33 is made of a bent metal rod-shaped member or pipe material. The first wire member 33 may be made of, for example, a round bar or a round pipe

The first wire member 33 includes a pair of top frames 33A spaced apart from each other in the lateral direction, each extending in the lateral direction, a pair of left and right side frames 33B extending downward and forward from the left and right edges of the respective top frames 33A, and a bottom frame 33C extending laterally and connecting the lower ends of the side frames 33B. The side frames 33B are each provided with a bent portion 33D that is bent laterally outward. Accordingly, the first wire member 33 includes a hexagonal frame shape in a front view. The top frame 33A is coupled to the forwardly extending portion 32B, and thus the first wire member 33 is fixed to the stay 21

As shown in FIG. 4, the second wire member 35 is also made of a bent metal rod-shaped member or pipe material. The second wire member 35 may be made of, for example, a round bar or a round pipe

The second wire member 35 includes a pair of left and right vertical frames 35A coupled to a bottom frame 33C and extending rearward and upward, and a horizontal frame 35B extending laterally and connecting the upper ends of the vertical frames 35A

The second bracket 36 is made of a bent metal plate material. The second bracket 36 includes a first plate 36A whose main surface is coupled to the horizontal frame 35B, and a second plate 36B that extends upward from the upper edge of the first plate 36A and includes a main surface facing substantially forward

The speaker box 25 is arranged so that the lower portion of the front surface thereof contacts the rear surface of the second plate 36B from the rear side, and is coupled (fastened according to the present embodiment) to the rear surface of the second plate 36B. Accordingly, the speaker box 25 including the speaker body 28 is coupled to the stay 21 via the support member 31 and is supported by the seat back frame 10

The speaker grill 26 covers the front surface of the speaker box 25 and protects the speaker body 28

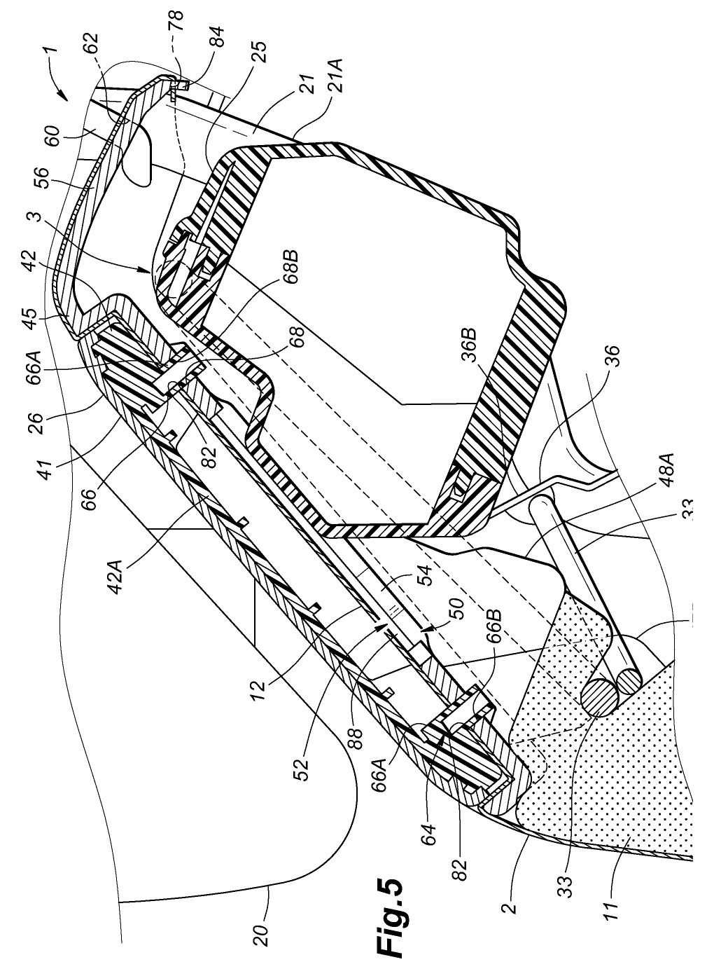

As shown in FIGS. 3 and 5, the speaker grill 26 includes a front grill 41 and a rear grill 42

As shown in FIG. 3, the front grill 41 has a flat plate shape extending in the lateral direction in a front view. The front grill 41 may include a grill frame 41A having a substantially rectangular plate shape, and a cover 41B stretched across the inside of the grill frame 41A. The grill frame 41A may be made of metal or resin, such as plastic, and the cover 41B may be made of fabric or the like that allows sound emitted from the speaker box 25 to pass through. The fabric constituting the cover 41B is preferably formed in a mesh shape. The front grill 41 may be made of a resin plate in which the grill frame 41A and the cover 41B are integrally molded

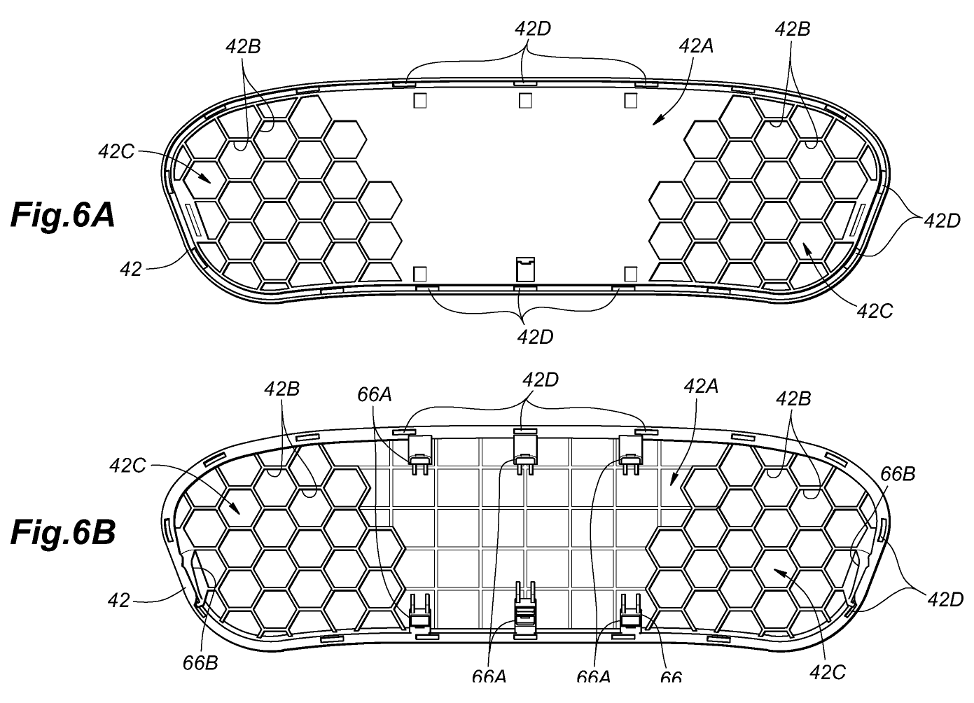

The rear grill 42 is also made of resin, such as plastic. As shown in FIGS. 6A and 6B, the rear grill 42 includes a grill body 42A including a surface facing in the front-and-rear direction, and having a substantially flat shape to which the front grill 41 is coupled at the front surface

The grill body 42A is formed in a substantially flat plate shape, and has a substantially rectangular plate shape extending laterally in a front view. The grill body 42A is preferably configured to be larger in the vertical and lateral directions than the front surface of the speaker box 25 in a front view. The grill body 42A is arranged in front of the speaker body 28

The grill body 42A is provided with a plurality of hexagonal holes 42B penetrating in the thickness direction thereof in front of the speaker body 28. The hexagonal holes 42B are arranged in a hexagonal lattice pattern, and a honeycomb structure 42C is formed in the portion of the grill body 42A arranged in front of the speaker body 28. This honeycomb structure 42C allows the speaker grill 26 to have sufficient rigidity while enabling the sound generated from the speaker body 28 to be transmitted effectively to the seated person

Coupling holes 42D penetrating in the front-and-rear direction are formed along the edge portion of the grill body 42A. Coupling claws 41C that are locked to the coupling holes 42D are provided along the outer peripheral edge of the rear surface of the grill frame 41A (see FIG. 3). In the present embodiment, the coupling claws 41C are provided on the rear surface of the grill frame 41A and protrude rearward. The coupling claws 41C are inserted into the coupling holes 42D and locked, and thus the front grill 41 is coupled to the front surface of the grill body 42A of the rear grill 42

As shown in FIG. 3, the speaker grill 26 is coupled to the stay 21 via an attachment member 45. In the following, the attachment member 45 will be described below

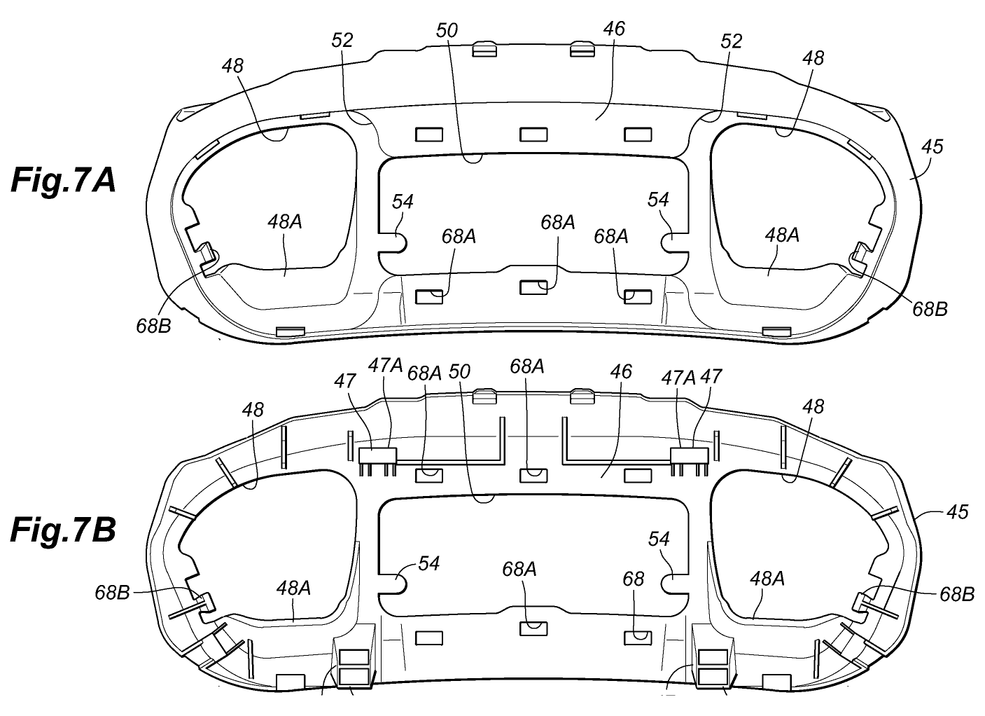

As shown in FIGS. 7A and 7B, the attachment member 45 is made of resin, such as plastic. The attachment member 45 includes a plate-shaped main portion 46 including a main surface facing in the front-and-rear direction, and a fixing portion 47 extending rearward from the main portion 46 and engaging with the first wire member 33

The main portion 46 has a substantially rectangular plate shape extending laterally. The main portion 46 has substantially the same shape as the grill body 42A of the speaker grill 26, and is configured to be slightly larger in the vertical and lateral directions than the grill body 42A. The main portion 46 is arranged in front of the speaker body 28 and behind the grill body 42A of the speaker grill 26. The main portion 46 is arranged behind the grill body 42A and in front of the speaker box 25

The main portion 46 is provided with two holes 48 arranged laterally side by side, and a central hole 50 arranged in the center of the two holes 48

The holes 48 are substantially circular through holes that penetrate the main portion 46 in the front-and-rear direction. The holes 48 are each arranged in front of the speaker body 28. The upper edge, the lower edge, and the left edge of the hole 48 arranged on the left side are arranged near the upper edge, the lower edge, and the left edge of the main portion 46, respectively. The upper edge, the lower edge, and the left edge of the hole 48 arranged on the right side are arranged near the upper edge, the lower edge, and the right edge of the main portion 46, respectively (see also FIG. 3)

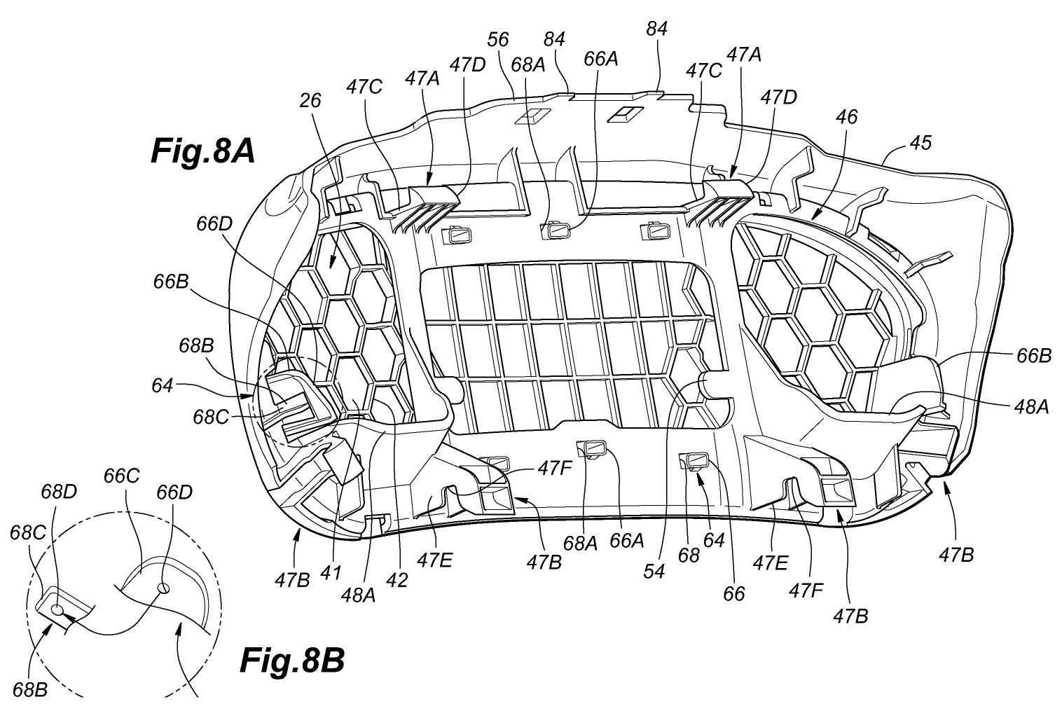

The lower edge of each hole 48 is provided with a protruding wall 48A (see also FIGS. 5 and 8) that protrudes rearward. As shown in FIG. 8, the protruding wall 48A is a raised wall extending along the lower edge of the hole 48

As shown in FIGS. 7A and 7B, the central hole 50 is a substantially rectangular hole that penetrates the main portion 46 in the front-and-rear direction, and is arranged substantially in the center of the two holes 48. The central hole 50 is provided to reduce the weight of the attachment member 45, and may be formed as a so-called lightening hole for reducing weight

As shown in FIG. 7A, the front surface of the main portion 46 is provided with two receiving recesses 52 recessed rearward. The receiving recesses 52 each extend in the circumferential direction along the outer periphery of the hole 48. The receiving recess 52 preferably extends along the entire outer periphery of the hole 48. In the present embodiment, each of the receiving recesses 52 contacts the central hole 50 at the respective inner edge on the left or right side. However, the present invention is not limited to this, and a gap may be provided between the receiving recess 52 and the central hole 50

A supporting piece 54 extending inward of the central hole 50 is provided at the edge portion of the central hole 50. The supporting piece 54 has a plate shape and includes a surface facing in the same direction as the main portion 46. In the present embodiment, the supporting pieces 54 are provided at the left edge and the right edge of the central hole 50, respectively. The supporting piece 54 provided at the left edge and the supporting piece 54 provided at the right edge are provided at positions aligned in the up-and-down direction. The supporting piece 54 provided at the left edge extends toward the right, and the supporting piece 54 provided at the right edge extends toward the left. That is, the two supporting pieces 54 extend in directions approaching each other

As shown in FIG. 7B, the fixing portion 47 includes an upper fixing portion 47A provided on the upper portion of the rear surface of the main portion 46, and a lower fixing portion 47B provided on the lower portion of the rear surface of the main portion 46. In the present embodiment, on the rear surface of the main portion 46, two upper fixing portions 47A are arranged laterally side by side, and four lower fixing portions 47B are arranged laterally side by side

As shown in FIG. 8, each upper fixing portion 47A includes an upper base portion 47C protruding rearward from the upper portion of the rear surface of the main portion 46, and a locking claw 47D protruding upward from the tip of the upper base portion 47C. The locking claw 47D is locked to the top frame 33A of the first wire member 33, so that the upper fixing portion 47A is latched to the first wire member 33 from below

Each lower fixing portion 47B includes a lower base portion 47Eprotruding rearward from the lower portion of the rear surface of the main portion 46, and a latching recess 47F recessed upward from the lower edge of the lower base portion 47E. The bottom frame 33C of the first wire member 33 is received in the latching recess 47F, and the lower fixing portion 47B is latched to the bottom frame 33C of the first wire member 33 from above

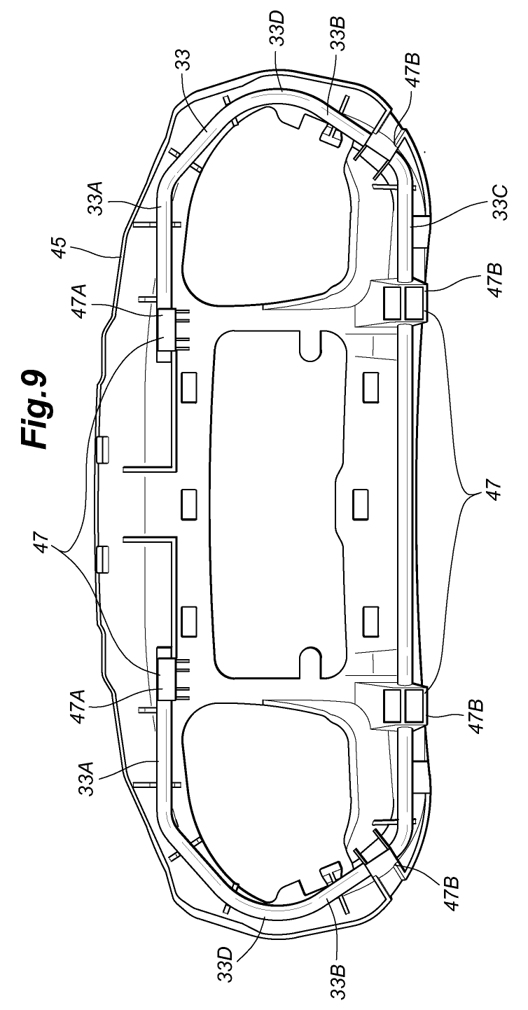

As shown in FIG. 9, the upper fixing portion 47A and the lower fixing portion 47B each engage with the first wire member 33, and thus the attachment member 45 is fixed to the first wire member 33. Accordingly, the attachment member 45 is fixed to the stay 21 via the first wire member 33. By providing the first wire member 33 on the stay 21 in this manner, the attachment member 45 can be easily attached to the stay 21

As shown in FIG. 5, the protruding wall 48A extends above the first wire member 33 to the rear of the bottom frame 33C of the first wire member 33. The protruding wall 48A may contact the lower edge of the speaker body 28 at a portion

As shown in FIG. 8A, the attachment member 45 may be provided with a tubular portion 56 that extends rearward from the peripheral edge of the main portion 46. As shown in FIG. 5, the tubular portion 56 covers the speaker box 25 from above, below, left, and right, and protects the speaker box 25

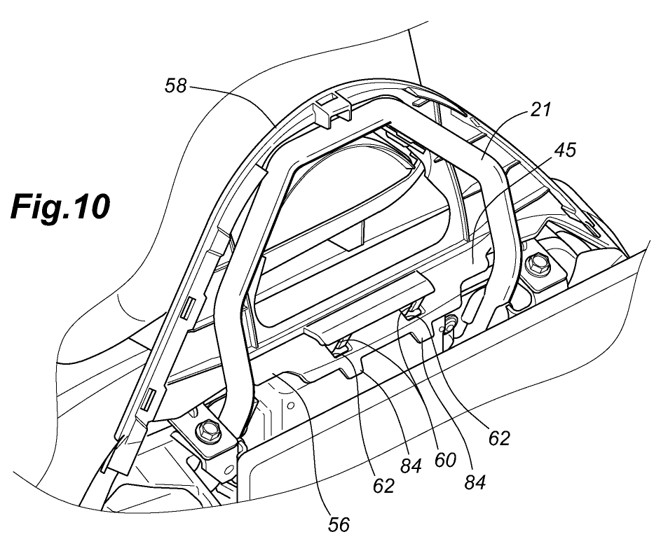

As shown in FIG. 10, in the present embodiment, a panel 58 made of resin is attached to the upper portion of the stay 21. The panel 58 is provided with panel locking claws 60 that protrude downward. The upper portion of the tubular portion 56 is provided with tubular portion locking holes 62 penetrating in the thickness direction thereof at positions aligned with the panel locking claws 60. The panel locking claws 60 are inserted into the tubular portion locking holes 62, and thus the detachment of the attachment member 45 from the stay 21 is prevented

As shown in FIG. 8A, the speaker grill 26 and the attachment member 45 are coupled to each other via a locking structure 64. The locking structure 64 includes a locking portions 66 provided on the speaker grill 26 and a locked portions 68 provided on the attachment member 45. The locking portions 66 protrude from the speaker grill 26 toward the attachment member 45 and engage with the locked portions 68 provided on the attachment member 45

The locking portion 66 is provided on the grill body 42A of the rear grill 42. The locking portion 66 includes first locking portions 66A provided on the upper edge and the lower edge of the rear surface of the grill body 42A, and second locking portions 66B provided on the left edge and right edge of the rear surface of the grill body 42A

The locked portions 68 are provided on the main portion 46 of the attachment member 45. The locked portion 68 includes the first locked portion 68A engaging with the first locking portion 66A and a second locked portion 68B engaging with the second locking portion 66B

Three first locking portions 66A are arranged at equal intervals in the lateral direction on the upper edge and the lower edge of the main portion 46, respectively. The first locked portions 68A are provided at positions corresponding to the first locking portions 66A of the grill body 42A. In the present embodiment, the first locking portion 66A is constituted by the locking claw protruding rearward from the rear surface of the grill body 42A, and the first locked portion 68A is constituted by the locking hole penetrating the main portion 46. The locking claw is inserted into the locking hole and hooked onto the edge portion defining the locking hole, and thus the first locking portion 66A is locked to the first locked portion 68A

Each second locking portion 66B protrudes rearward and passes near the edge portion of the hole 48 of the attachment member 45. As shown in FIGS. 8A and 8B, each second locking portion 66B includes an inner piece 66C including a main surface facing in the lateral direction and having a flat plate shape extending rearward, and a locking recess 66D recessed at the outermost end of the outer surface of the inner piece 66C

The second locked portion 68B is provided at the edge portion of the hole 48. As shown in FIGS. 8A and 8B, the second locked portion 68B includes an outer piece 68C protruding rearward along outer surface of the inner piece 66C, and a locking protrusion 68D provided at the tip of the outer piece 68C and inserted into the locking recess 66D. The locking protrusion 68D is inserted into the locking recess 66D, and thus the outer piece 68C is coupled to the inner piece 66C. Accordingly, the left and right second locked portions 68B are locked to the corresponding second locking portions 66B

As shown in FIG. 8A, the first locking portion 66A engages with the first locked portion 68A, and the second locking portion 66B engages with the second locked portion 68B, and thus the speaker grill 26 is coupled to the attachment member 45 at the four edge portions on the top, bottom, left, and right. As shown in FIG. 9, the attachment member 45 is coupled to the first wire member 33, and therefore the speaker grill 26 is coupled to the stay 21 via the attachment member 45. Accordingly, the speaker grill 26 is supported by the stay 21 in front of the speaker box 25

The front grill 41 is fixed to the attachment member 45 via the rear grill 42. That is, the rear grill 42 functions as a fixing member for fixing the front grill 41 to the attachment member 45

As shown in FIG. 1, the speaker device 3 is fitted into the upper portion of the seat back 6. The pad member 11 is arranged so as to cover the front surface and the left and right side surfaces of the seat back frame 10

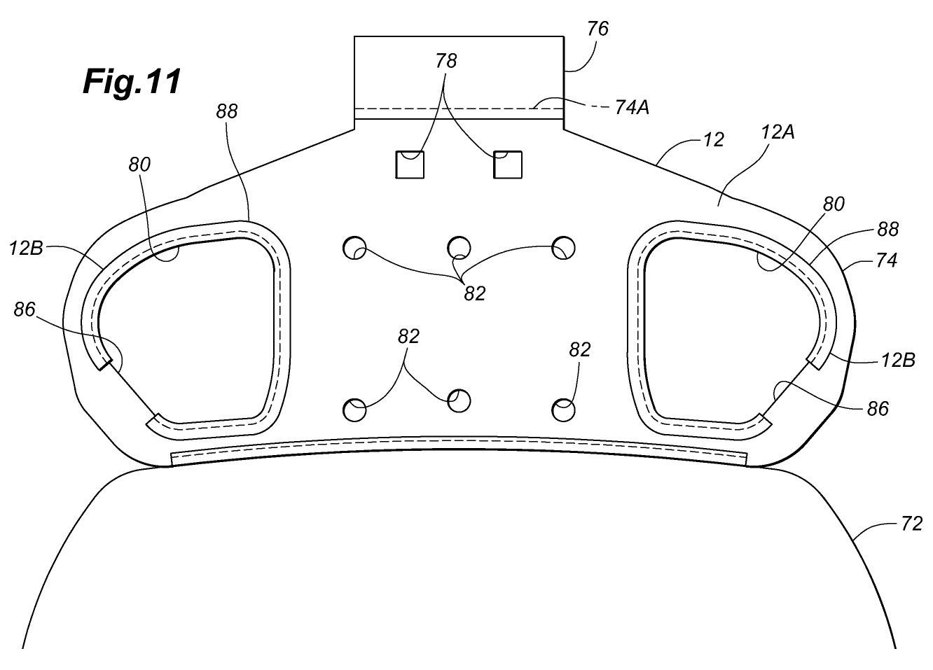

FIG. 11 shows a schematic diagram of the back surface of the skin material 12 provided on the upper portion of the seat back 6. The skin material 12 is made of a sheet-like material, such as fabric or leather. The skin material 12 includes a lower skin 72 covering the outer surface of the pad member 11, and an upper skin 74 coupled to the upper edge of the lower skin 72. The lower skin 72 is arranged so as to contact the front surface of the pad member 11 at the back surface, and the upper skin 74 is arranged so as to cover the speaker device 3 (specifically, the speaker grill 26)

The upper skin 74 includes a tongue piece 76, a latching hole 78 provided near the tongue piece 76, two openings 80 each having a shape conforming to the corresponding speaker body 28, and a plurality of locking holes 82 provided between the two openings 80

The tongue piece 76 is provided at the edge portion of the upper skin 74. More specifically, the tongue piece 76 is arranged at the edge portion of the upper skin 74 away from the lower skin 72. The tongue piece 76 is formed by a band-shaped portion provided on the edge portion of the upper skin 74 being folded back and sewed to form a bag-like shape. Accordingly, the tongue piece 76 can also be referred to as a bag-like sewn portion that is sewn to form a bag-like shape

In the present embodiment, a seam 74A (see FIG. 11) is formed by the band-shaped portion of the upper skin 74 being folded back at substantially the center, and the edge portions being sewn together. Accordingly, the tongue piece 76 is configured to have a bag-like shape with openings on left and right sides

The latching hole 78 is a hole penetrating the upper skin 74. In the present embodiment, two latching holes 78 are arranged laterally side by side at the position closer to the lower skin 72 than the tongue piece 76

The upper rear edge of the tubular portion 56 is provided with two latching portions 84 that protrude rearward. The latching hole 78 is latched onto the latching portion 84, and thus the upper skin 74 is coupled to the attachment member 45 at the upper portion. This allows the skin material 12 to be coupled to the attachment member 45

Each edge portion of the opening 80 is provided with a notch 86 cut outward. In the present embodiment, the notch 86 is provided at the left edge of the opening 80 on the left side and at the right edge of the opening 80 on the right side

The skin material 12 is provided with reinforcing portions 88 extending along the edge portions of the openings 80. Each reinforcing portion 88 may be formed by coupling a rigid member 12B, which is harder than a fabric material 12A, to the fabric material 12A that constitutes the skin material 12. In the present embodiment, the rigid member 12B is constituted by a trim cord extending along the edge portion of the opening 80, and the reinforcing portion 88 is formed by sewing the trim cord to the back surface (i.e., the rear surface) of the fabric material 12A. In FIG. 11, the broken line indicates the seam portion between the rigid member 12B (trim cord) and the fabric material 12A. In this way, when the reinforcing portion 88 is formed by coupling the hard material to the back side of the fabric material 12A, the reinforcing portion 88 projects from the back surface of the fabric material 12A. By providing the reinforcing portion 88 along the edge portion of the opening 80, the edge portion of the opening 80 can be reinforced

In the present embodiment, the reinforcing portion 88 is arranged at a position that avoids the notch 86 provided at the edge portion of the opening 80. More specifically, the reinforcing portion 88 extends from a position near the upper end of the notch 86 along the edge portion of the opening 80 and reaches a position near the lower end of the notch 86

The locking holes 82 are arranged in a row each on the upper and lower sides. Three locking holes 82 are provided in each of the upper and lower rows. The locking holes 82 in each row are arranged at equal intervals in the lateral direction

The skin material 12 is arranged so that the opening 80 overlaps the hole 48, and the locking hole 82 overlaps the first locked portion 68A from the front. The first locking portion 66A passes through the locking hole 82 and engages with the first locked portion 68A (see FIG. 5), and the second locking portion 66B passes through the notch 86 and engages with the second locked portion 68B, thereby coupling the speaker grill 26 to the attachment member 45. At this time, as can be seen from FIGS. 3 and 5, the skin material 12 is sandwiched between the speaker grill 26 and the attachment member 45 at the edge portions of the openings 80 and at the portion between the two openings 80. The reinforcing portion 88 of the skin material 12 is accommodated in the receiving recess 52 and is restricted from moving in a direction along the main portion 46 of the attachment member 45

The speaker body 28 needs to be supplied with signals to generate sound. Accordingly, the vehicle seat 1 is provided with a routing structure 100 for connecting the speaker body 28 with a control device (not shown) for controlling the output of the speaker body 28

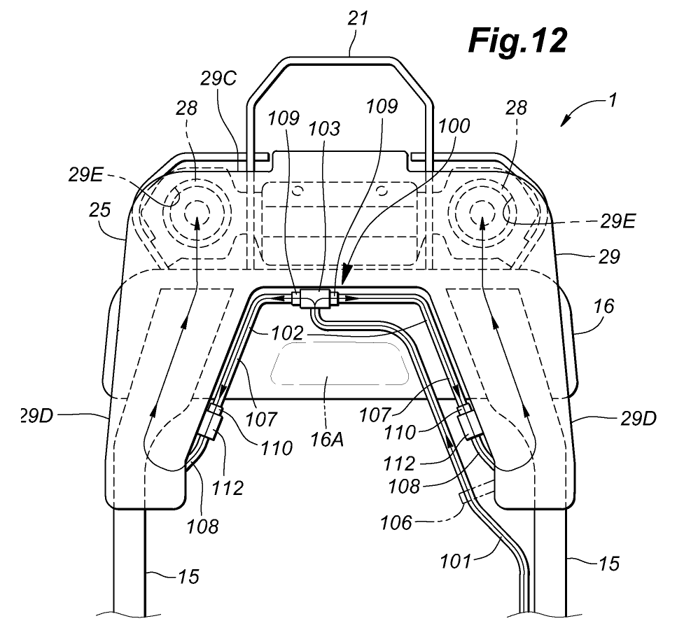

FIG. 12 shows a rear view of the upper portion of the vehicle seat 1 according to a modified embodiment, which has a configuration similar to that of the vehicle seat 1 shown in FIG. 4. For simplicity, only the seat back frame 10, the stay 21, the speaker box 25, and the routing structure 100 are shown in FIG. 4

As shown in FIG. 12, the vehicle seat 1 includes a pair of left and right side members 15 spaced apart from each other in the lateral direction, and the upper frame 16 (also referred to as the upper member) that connects the upper portions of the left and right side members 15, as in a case shown in FIG. 4. In the example shown in FIG. 12, the upper frame 16 has a plate shape and includes a surface facing substantially in the front-and-rear direction. At the lower portion of the upper frame 16, a bulging portion 16A that bulges rearward is provided at the lateral center thereof

The stay 21 similar to that shown in FIG. 4 is provided in the upper portion of the upper frame 16. The speaker box 25 is coupled to the stay 21

The speaker box 25 includes two speaker bodies 28 and the housing 29. The housing 29 is formed by coupling the front member 29A to the rear member 29B, as in a case of FIG. 4, and includes a sealed internal space therein

As shown in FIG. 12, the housing 29 includes a housing upper portion 29C that constitutes the upper portion and extends in the lateral direction, and a pair of left and right housing lower portions 29D that constitute the lower portion and extend downward from the left and right edges of the housing upper portion 29C. The housing 29 has a substantially U-shape in a front view. The internal space is formed so as to extend across the housing upper portion 29C and the two housing lower portions 29D

The housing upper portion 29C includes through holes 29E spaced apart from each other in the lateral direction. The speaker bodies 28 are each coupled to the housing 29 at a position corresponding to the respective through hole 29E. Each housing lower portion 29D extends along the rear surface of the upper frame 16 on the left and right sides of the bulging portion 16A, and extends below the lower edge of the upper frame 16

The routing structure 100 includes a first harness 101 provided on the control device side, and two second harnesses 102 each connected at one end to the end of the first harness 101 and at the other end to the corresponding speaker body 28

The first harness 101 extends upward along the side member 15 on either the left or right side, and includes at the extended end thereof a branch coupler 103, which is a connector. The extended end of the first harness 101 may be fixed to the back surface (rear surface) of the upper frame 16 by a fixing member (not shown), such as a clip. The first harness 101 may be fixed to the outer surface of the housing lower portion 29D, i.e., the inner side surface of the seat, by a fixing member 106, such as a clip

Each second harness 102 includes an outer harness 107 extending from the first harness 101 to the outer surface of the housing lower portion 29D, and an inner harness 108 extending from the outer surface of the housing lower portion 29D to the speaker body 28

Each outer harness 107 includes an outer first coupler 109 at one end thereof. The outer first couplers 109 are connectors and are connected to the branch coupler 103. Accordingly, the first harness 101 branches into two outer harnesses 107 at the branch coupler 103. The outer harnesses 107 each extend along the back surface of the upper frame 16 and reach the inner side surface of the seat of the housing lower portion 29D. In the present embodiment, the outer harness 107 further extends downward along the inner side surface of the seat of the housing lower portion 29D. Each outer harness 107 includes an outer second coupler 110 at the other end thereof

Each inner harness 108 includes an inner coupler 112 at one end thereof. The inner coupler 112 is a connector and is connected to the outer second coupler 110. The inner coupler 112 is fixed to the outer surface of the housing lower portion 29D, i.e., the inner side surface of the seat. The inner harness 108 may be fixed to the housing lower portion 29D near one end thereof by the fixing member, such as a clip. Alternatively, instead of the inner coupler 112, the outer second coupler 110 may be fixed to the outer surface of the housing lower portion 29D, i.e., the inner side surface of the seat

The inner coupler 112 may be arranged below the upper frame 16 as seen in a front-rear direction. However, the inner coupler 112 may overlap the lower edge of the upper frame 16 as seen in a front-rear direction. When the first harness 101 is fixed by the fixing member 106, the fixing member 106 may be arranged below the upper frame 16 as seen in a front-rear direction. The inner harness 108 extends from the inner coupler 112 to the interior space via a through-hole (not shown) provided in the housing lower portion 29D, and is connected to the speaker body 28 at the other end

This forms a path (see arrows in FIG. 12) that supplies signals and power through the first harness 101 and the second harness 102 to the speaker body 28

Next, the manufacturing method of the vehicle seat 1 will be described. The manufacturing method of the vehicle seat 1 includes the steps of preparing the seat frame 22 including the stay 21, coupling the support member 31 to the stay 21, assembling the pad member 11 and the skin material 12 to the seat frame 22, attaching the speaker box 25 and the attachment member 45 to the support member 31, latching the latching hole 78 of the skin material 12 to the latching portion 84 of the attachment member 45, and coupling the speaker grill 26 to the attachment member 45 while sandwiching the skin material 12

In the step of latching the latching hole 78 to the latching portion 84, the operator manufacturing the vehicle seat 1 may grasp and pull the tongue piece 76 upward and rearward to hook the latching hole 78 to the latching portion 84. In this manner, it is possible to easily manufacture the vehicle seat 1 by using the tongue piece 76

In the present embodiment, the tongue piece 76 is configured to have a bag-like shape with openings on the left and right sides. Accordingly, the operator can easily hook the latching hole 78 onto the latching portion 84 by engaging his or her hands with the left and right openings and pulling the tongue piece 76

In the present embodiment, the tongue piece 76 is configured to have a bag-like shape with openings on the left and right sides, however, the tongue piece 76 may be in any shape that is easy for an operator to grasp when latching the latching hole 78 to the latching portion 84. For example, in FIG. 11, the tongue piece 76 is sewn at the edge portion on the side away from the lower skin 72 (the lateral direction in the plane of FIG. 11), but the tongue piece 76 may also be sewn at both the left and right edges (the up-and-down direction in the plane of FIG. 11). Alternatively, the edge portion of the tongue piece 76 may not be sewn, and instead a resin plate and the like may be adhered thereto

Further, when manufacturing the vehicle seat 1, an operator may connect the outer harness 107 to the first harness 101 and the inner harness 108 for routing to the speaker body 28. Since the inner coupler 112 is fixed to the outer surface of the housing lower portion 29D, the outer harness 107 can be easily connected to the inner harness 108 when assembling the vehicle seat 1, thereby improving the ease of assembly of the vehicle seat 1. Further, when the inner coupler 112 is provided below the upper frame 16, the upper frame 16 is less likely to obstruct the view of the inner coupler 112, which further improves the ease of assembly of the vehicle seat 1

Next, the effects of the vehicle seat 1 configured in this manner will be described. The edge portion of the opening 80 in the skin material 12 is sandwiched between the speaker grill 26 and the attachment member 45. Accordingly, the edge portion of the opening 80 is stably fixed to the seat frame 22, and the edge portion of the opening 80 of the skin material 12 can be prevented from peeling off

Further, the locking portion 66 is coupled to the locked portion 68 through the locking hole 82 and the opening 80 provided in the skin material 12. Accordingly, it is possible to prevent the skin material 12 from detaching from between the speaker grill 26 and the attachment member 45

Further, the reinforcing portion 88 of the skin material 12 is accommodated in the receiving recess 52. Accordingly, the skin material 12 can be accurately arranged at the position where the opening 80 overlaps the hole 48, and the skin material 12 can be arranged at an appropriate position. Further, the positional deviation of the skin material 12 can be prevented

The outer edge of the opening 80 is provided with a notch 86 cut outward, and the second locking portion 66B passes through the notch 86 and extends rearward to and engages with the second locked portion 68B. On the other hand, the reinforcing portion 88 extends along the outer periphery of the opening 80 at a position that avoids the notch 86, and the reinforcing portion 88 is not provided in the portion of the skin material 12 near the notch 86. Accordingly, when the second locking portion 66B is passed through the notch 86, the portion of the skin material 12 near the notch 86 can be easily deformed, and the second locking portion 66B can be easily engaged with the second locked portion 68B

The left and right edges of the central hole 50 are provided with the supporting pieces 54 extending inward of the seat. As shown in FIG. 5, the supporting piece 54 is arranged behind the skin material 12 (i.e., on the inside of the seat). Accordingly, by providing the supporting piece 54, the rearward movement of the skin material 12 is restricted, and the occurrence of slack of the skin material 12 is prevented

The left edge and the right edge of the central hole 50 are provided with the supporting pieces 54, respectively. Accordingly, it is possible to restrict rearward movement of the skin material 12 at both left and right edges of the central hole 50, thereby effectively preventing slack of the skin material 12 from occurring

The speaker grill 26 is attached to the attachment member 45 coupled to the first wire member 33. That is, the speaker grill 26 is coupled to the first wire member 33 via the attachment member 45. The first wire member 33 is coupled to the stay 21, and the stay 21 is coupled to the upper portion of the seat back frame 10. Accordingly, the speaker grill 26 is supported by the seat back frame 10 via the attachment member 45 and the first wire member 33

The speaker box 25 is coupled to the first wire member 33 via the second bracket 36. Accordingly, the speaker box 25 is coupled to the stay 21 via the first wire member 33 and not via the attachment member 45

On the other hand, the airbag module 18 is coupled to the lower portion of the seat back frame 10. This allows the speaker grill 26 and the speaker box 25 to be arranged at a position where the deployment of the airbag 18A is not interfered with

This concludes the description of the specific embodiments, but the present invention is not limited to the above embodiments or modifications, and can be widely modified and implemented

In the above embodiment, the locking portion 66 is arranged to protrude from the rear grill 42 toward the attachment member 45, but the embodiment is not limited thereto. The locking portion 66 may protrude from either one of the rear grill 42 and the attachment member 45 toward the other, and the other may be provided with the locked portion 68. In the above embodiment, the first locking portion 66A is constituted by the locking claw, and the first locked portion 68A is constituted by the locking hole, but the first locking portion 66A may be constituted by the locking hole, and the first locked portion 68A may be constituted by the locking claw. Similarly, a recess is provided in the second locking portion 66B and a protrusion inserted into the recess of the second locking portion 66B is provided in the second locked portion 68B, but a protrusion may be provided in the second locking portion 66B and a recess receiving the protrusion of the second locking portion 66B may be provided in the second locked portion 68B

In the above embodiment, the reinforcing portion 88 is constituted by coupling a material harder than the fabric material 12A to the back side of the fabric material 12A, but may be constituted by coupling a material harder than the fabric material 12A to the front side of the fabric material 12A. In this case, the rear surface of the rear grill 42 may be provided with the receiving recess 52 for receiving the reinforcing portion 88 thereof

In the above embodiment, as shown in FIG. 2, the first bracket 32 is configured to include the laterally extending portion 32A and the forwardly extending portion 32B, but the embodiment is not limited thereto

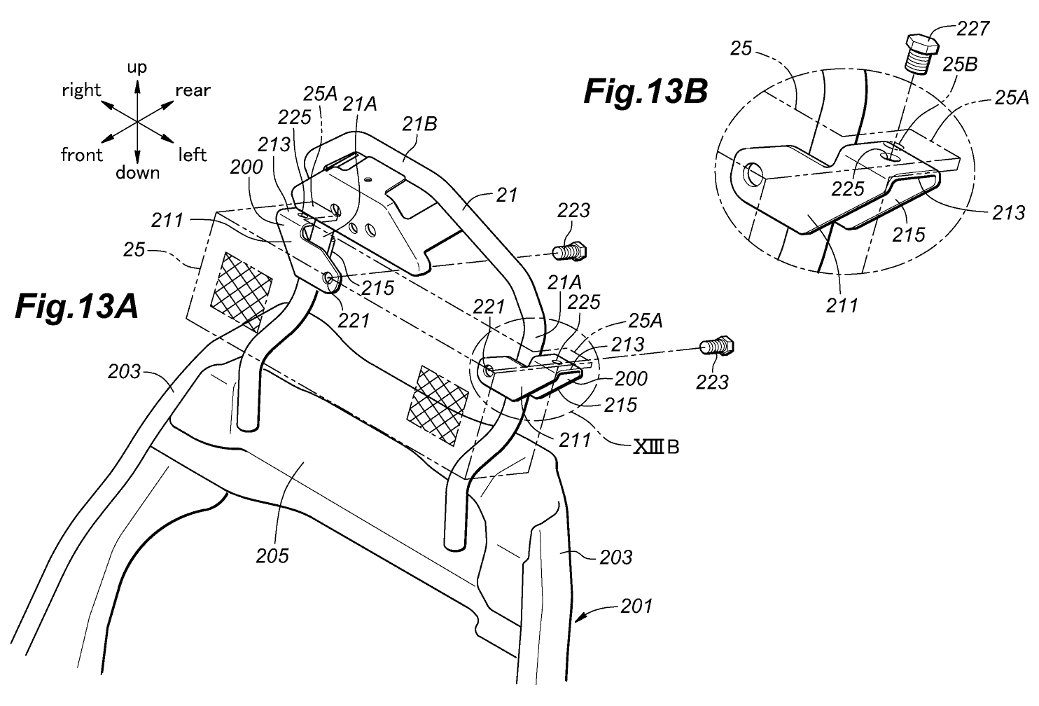

FIG. 13A shows a perspective view of a first bracket 200 according to a modified embodiment. FIG. 13 also shows the stay 21 to which the first bracket 200 is provided, and a seat back frame 201 to which the stay 21 is coupled

As shown in FIG. 13A, the seat back frame 201 includes a pair of left and right side members 203 formed by bending sheet metal members, and an upper member 205 connecting the upper edges of the side members 203. In the example shown in FIG. 13, the upper member 205 is formed by bending a sheet metal member into a substantially box shape, and is coupled to the side member 203 at the left and right edges

In the example shown in FIG. 13A, as in a case shown in FIG. 2, the stay 21 is made of a bent metal round pipe material. The stay 21 includes a pair of left and right vertical portions 21A, and a lateral portion 21B connecting the upper ends of the left and right vertical portions 21A

The lower portions of the vertical portions 21A are fixed to the front surface of the upper member 205 by welding. The first brackets 200 are provided to the vertical portions 21A, respectively, as in a case shown in FIG. 2. Each first bracket 200 is made of a bent sheet metal member

As shown in FIG. 13A, the first bracket 200 includes a plate-shaped front plate 211 including a surface facing in the front-and-rear direction, a plate-shaped horizontal portion 213 including a surface facing in the up-and-down direction, and a plate-shaped rear plate 215 including a surface facing in the front-and-rear direction. The front plate 211 is directly coupled to the front surface of the vertical portion 21A and extends from the vertical portion 21A to the outside of the seat. The horizontal portion 213 extends rearward from the upper edge of the front plate 211 at the outer side of the seat of. The rear plate 215 extends downward from the rear edge of the horizontal portion 213 and further extends toward the inside of the seat, and is directly coupled to the rear surface of the vertical portion 21A

Each front plate 211 is provided with a first fastening hole 221 penetrating in the front-and-rear direction. The speaker box 25 is fastened to the front plate 211 of the first bracket 200 by a first fastener 223 (such as a bolt) inserted into the first fastening hole 221 at the rear surface

In the present embodiment, as shown in FIG. 13B, the speaker box 25 includes a pair of fastened portions 25A that are arranged to overlap each of the horizontal portions 213 from above. In the present embodiment, the fastened portion 25A has a plate shape and includes a surface facing in the up-and-down direction

Each horizontal portion 213 includes a second fastening hole 225 penetrating in the up-and-down direction. The fastened portions 25A are each provided with a through hole 25B penetrating in the up-and-down direction at a position aligned with the second fastening hole 225. The fastened portion 25A is fastened to the horizontal portion 213 by a second fastener 227 (such as a bolt) inserted into the through hole 25B and the second fastening hole 225. Accordingly, the speaker box 25 is fastened to the front plate 211 and the horizontal portion 213 of the first bracket 200, and is coupled to the stay 21 via the first bracket 200

In the example shown in FIGS. 13A and 13B, the speaker box 25 is fastened to the front plate 211 and the horizontal portion 213, but the speaker box 25 may be fastened in any manner as long as the speaker box 25 is coupled to the first bracket 200, and for example, the speaker box 25 may be fastened to at least one of the front plate 211, the horizontal portion 213, and the rear plate 215

1. A vehicle seat comprising:
a seat body including a frame, a pad member supported by the frame, and a skin material covering an outer surface of the pad member; and
a speaker device including a speaker box and a speaker grill, wherein
the speaker box is coupled to a wire member provided on the frame,
the speaker grill is coupled to the wire member via an attachment member,
the skin material is provided with an opening for allowing sound emitted from the speaker box to pass through, and
the speaker grill is coupled to the attachment member with an edge portion of the opening sandwiched between the speaker grill and the attachment member.

2. The vehicle seat according to claim 1, wherein one of the speaker grill and the attachment member is provided with a locking portion protruding toward the other of the speaker grill and the attachment member,
the other of the speaker grill and the attachment member is provided with a locked portion to be locked to the locking portion protruding from the one of the speaker grill and the attachment member, and
the skin material is provided with a locking hole for allowing the locking portion to pass through.

3. The vehicle seat according to claim 1, wherein one of the speaker grill and the attachment member is provided with a locking portion protruding toward the other of the speaker grill and the attachment member,
the other of the speaker grill and the attachment member is provided with a locked portion to be locked to the locking portion protruding from the one of the speaker grill and the attachment member, and
the locking portion passes through the opening.

4. The vehicle seat according to claim 3, wherein the skin material is provided with a reinforcing portion extending along the edge portion of the opening.

5. The vehicle seat according to claim 4, wherein the reinforcing portion projects from a back surface of the skin material, and
the attachment member is provided with a receiving recess for receiving the reinforcing portion.

6. The vehicle seat according to claim 4, wherein the edge portion of the opening is provided with a notch cut outward,
the locking portion passes through the notch and engages with the locked portion, and
the reinforcing portion is arranged at a position that avoids the notch.

7. The vehicle seat according to claim 1, wherein the attachment member is provided with a central hole, and
a supporting piece extending inward is provided on an edge portion of the central hole.

8. The vehicle seat according to claim 1, wherein the speaker box is provided with two speaker bodies,
the attachment member includes two holes spaced apart from each other in a lateral direction, and a central hole arranged in a center of the holes,
each hole is arranged at a position that overlaps the corresponding speaker body, and
left and right edges of the central hole are provided with supporting pieces extending in directions approaching each other, respectively.

9. The vehicle seat according to claim 1, wherein the skin material is provided with at least one latching hole,
the attachment member is provided with a latching portion where the latching hole is latched, and
the skin material is provided with a tongue piece for an operator to grasp when the latching hole is latched onto the latching portion.

10. The vehicle seat according to claim 9, wherein the tongue piece is formed by an upper edge of the skin material being folded back to a back surface and sewn, and forms a bag-like shape with openings on left and right sides.

11. The vehicle seat according to claim 1, wherein the frame includes a seat back frame forming a framework of a seat back, and a headrest stay coupled to an upper portion of the seat back frame,
the wire member is coupled to the headrest stay, and
the attachment member is fixed to the wire member.

12. The vehicle seat according to claim 1, wherein the frame includes a seat back frame forming a framework of a seat back, and a headrest stay extending upward from an upper end of the seat back frame,
an airbag module including an airbag configured to deploy forward is provided in a lower portion of the seat back frame, and
the attachment member is coupled to the headrest stay.
